(19) United States
(12) Patent Application Publication
(10) Pub. No.: US 2025/0301115 A1
(43) Pub. Date: Sep. 25, 2025

(54) METHOD AND DEVICE FOR VIEWPORT-BASED ATLAS SELECTION

(71) Applicant: Electronics and Telecommunications Research Institute, Daejeon (KR)

(72) Inventors: Sang Woon KWAK, Daejeon (KR); Gwangsoon LEE, Daejeon (KR); Hong Chang SHIN, Daejeon (KR)

(73) Assignee: Electronics and Telecommunications Research Institute, Daejeon (KR)

(21) Appl. No.: 19/086,288

(22) Filed: Mar. 21, 2025

(30) Foreign Application Priority Data
Mar. 21, 2024 (KR) 10-2024-0039196

(51) Int. Cl. H04N 13/117; H04N 13/161; H04N 13/178

(52) U.S. Cl. CPC H04N 13/117; H04N 13/161; H04N 13/178

(57) ABSTRACT

An image encoding method according to the present disclosure includes encoding each of a plurality of groups; and generating metadata for each of the plurality of groups. In this case, each of the plurality of groups may be encoded independently, and each of the plurality of groups may be composed of at least one atlas.

### CROSS-REFERENCE TO RELATED APPLICATIONS

This application claims the benefit of earlier filing date and right of priority to Korean Application NO. 10-2024-0039196, filed on Mar. 21, 2024, the contents of which are all hereby incorporated by reference herein in their entirety.

### TECHNICAL FIELD

The present disclosure relates to a partition decoding and reproduction technology for continuously providing an omnidirectional image capable of supporting a motion parallax in response to a viewer's left and right/up and down rotation as well as left and right/up and down movement in order to play a natural omnidirectional image through a VR terminal.

### BACKGROUND ART

A virtual reality service is evolving in a direction of providing a service in which a sense of immersion and realism are maximized by generating an omnidirectional image in a form of an actual image or CG (Computer Graphics) and playing it on HMD, a smartphone, etc. Currently, it is known that 6 Degrees of Freedom (DoF) should be supported to play a natural and immersive omnidirectional image through HMD. For a 6DoF image, an image which is free in six directions including (1) left and right rotation, (2) top and bottom rotation, (3) left and right movement, (4) top and bottom movement, etc. should be provided through a HMD screen. But, most of the omnidirectional images based on an actual image support only rotary motion. Accordingly, a study on a field such as acquisition, reproduction technology, etc. of a 6DoF omnidirectional image is actively under way.

### DISCLOSURE

### Technical Problem

The present disclosure is to provide a method for selecting an optimal group or atlas based on user view information, in continuously reproducing a wide range of immersive videos by partially decoding and rendering an immersive video partitioned into groups.

### Technical Solution

A viewport-based atlas selection method, device and recording medium according to the present disclosure may include buffering and preprocessing metadata and user view information, calculating a correlation value representing a correlation at a user view position for each atlas based on the metadata and user view information, and selecting a group or an atlas used for MIV decoding and view image synthesis based on the correlation value.

In a viewport-based atlas selection method, device and recording medium according to the present disclosure, selecting the group or atlas may be performed based on a baseline between a viewport and each camera.

In a viewport-based atlas selection method, device and recording medium according to the present disclosure, when camera grouping is regularly performed based on a camera arrangement structure, selecting the group or atlas may be performed by considering only a decision boundary without considering a baseline with all cameras.

In a viewport-based atlas selection method, device and recording medium according to the present disclosure, the selected group or atlas may be selected as a group or an atlas having the highest correlation value with the user view position among a plurality of groups or atlases, and the plurality of groups or atlases may be divided by the decision boundary.

In a viewport-based atlas selection method, device and recording medium according to the present disclosure, in selecting the group or atlas, when the highest correlation value at the user view position is at a position exceeding a threshold from the decision boundary of a group or an atlas having the highest correlation value with a previous user view position, a group or an atlas having the highest correlation value with the user view position may be selected, and when the highest correlation value at the user view position is at a position not exceeding the threshold from the decision boundary of a group or an atlas having the highest correlation value with the previous user view position, a group having the highest correlation value with the previous user view position may be selected.

In a viewport-based atlas selection method, device and recording medium according to the present disclosure, selecting the group or atlas may be performed based on a view direction difference between a viewport and each camera.

In a viewport-based atlas selection method, device and recording medium according to the present disclosure, selecting the group or atlas may be performed based on visibility for each camera for a viewport.

In a viewport-based atlas selection method, device and recording medium according to the present disclosure, the visibility may be determined based on how much sample points within the frustum space of each camera are projected within the image plane of each camera.

In a viewport-based atlas selection method, device and recording medium according to the present disclosure, selecting the group or atlas may be performed based on a baseline between a viewport and each camera, a view direction difference between the viewport and each camera and visibility for each camera for the viewport.

The technical objects to be achieved by the present disclosure are not limited to the above-described technical objects, and other technical objects which are not described herein will be clearly understood by those skilled in the pertinent art from the following description.

### Technical Effect

According to the configuration of the present disclosure, an optimal group or atlas may be selected based on user view information and metadata, in continuously reproducing a wide range of immersive videos by partially decoding and rendering an immersive video partitioned into groups.

A correlation for each group may be obtained by using viewport information and metadata, and a group and atlas ID selected based on this may be output. In obtaining a correlation, a function based on a baseline between a viewport and each camera, a view direction between a viewport and each camera and visibility for each camera and a viewport may be used.

According to the configuration of the present disclosure, partial decoding and partial space rendering may be performed by switching a group or an atlas required for rendering as a user view position changes, continuously reproducing a wide range of immersive videos even under limited performance and limited system resources of a terminal.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a block diagram of an immersive image processing device according to an embodiment of the present disclosure.

FIG. 2 is a block diagram of an immersive image output device according to an embodiment of the present disclosure.

FIG. 3 shows the entire structure of an immersive video receiving system based on the configuration of the present disclosure.

FIG. 4 is a diagram for specifically describing the operation process of a viewport-based atlas selector.

FIG. 5 shows an embodiment for a case where the unit of switching is a group and an atlas.

FIG. 6 shows an embodiment of a camera baseline-based VAS algorithm.

FIG. 7 shows contents related to an embodiment in which a group or an atlas is selected by using only a decision boundary.

FIG. 8 shows an embodiment in which a group or an atlas is selected based on a view direction difference between a viewport and each camera.

FIG. 9 shows an embodiment in which a group or an atlas is selected based on visibility for each camera for a viewport.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive image, when a user's viewing position is changed, refers to an image that a viewport image may be also dynamically changed. In order to implement an immersive image, a plurality of input images is required. Each of a plurality of input images may be referred to as a source image or a view image. A different view index may be assigned to each view image. An immersive image may be configured with images with a different view, and accordingly, an immersive image may be referred to as a multi-view image.

An immersive image may be classified into 3DoF (Degree of Freedom), 3DoF+, Windowed-6DoF or 6DoF type, etc. A 3DoF-based immersive image may be implemented by using only a texture image. On the other hand, in order to render an immersive image including depth information such as 3DoF+ or 6DoF, etc., a depth image (or, a depth map) as well as a texture image is also required.

It is assumed that the embodiments described below are for immersive image processing including depth information such as 3DoF+ and/or 6DoF, etc. In addition, it is assumed that a view image is configured with a texture image and a depth image.

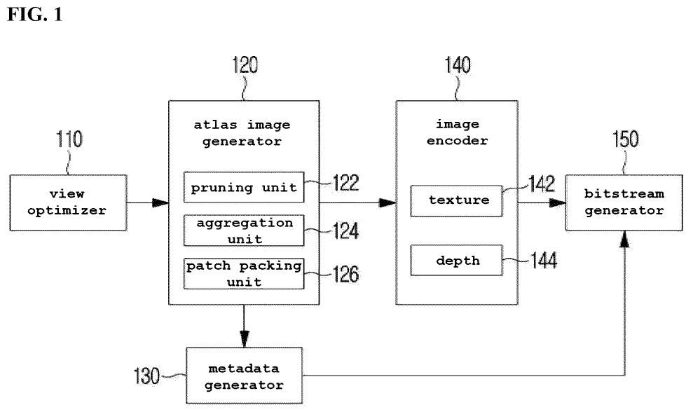

FIG. 1 is a block diagram of an immersive image processing device according to an embodiment of the present disclosure.

In reference to FIG. 1, an immersive image processing device according to the present disclosure may include a view optimizer 110, an atlas generation unit 120, a metadata generation unit 130, an image encoding unit 140, and a bitstream generation unit 150.

An immersive image processing device receives a plurality of pairs of images, intrinsic camera parameters and extrinsic camera parameters as input data to encode an immersive image. Here, a plurality of pairs of images includes a texture image (Attribute component) and a depth image (Geometry component). Each pair may have a different view. Accordingly, a pair of input images may be referred to as a view image. Each of the view images may be divided by an index. In this case, an index assigned to each view image may be referred to as a view or a view index.

Intrinsic camera parameters includes a focal distance, a position of a principal point, etc. and extrinsic camera parameters include translations, rotations, etc. of a camera. Intrinsic camera parameters and extrinsic camera parameters may be treated as a camera parameter or a (user's) view parameter.

A view optimizer 110 partitions view images into a plurality of groups. As view images are partitioned into a plurality of groups, independent encoding processing per each group may be performed. In an example, view images captured by N spatially consecutive cameras may be classified into one group. Thereby, view images that depth information is relatively coherent may be put in one group and accordingly, rendering quality may be improved.

In addition, a view optimizer 110 may classify view images into a basic image and an additional image. A basic image represents an image which is not pruned as a view image with the highest pruning priority and an additional image represents a view image with a pruning priority lower than a basic image.

In addition, a view optimizer 110 may determine at least one of the view images as a basic image. A view image which is not selected as a basic image may be classified as an additional image.

An Atlas generation unit 120 may perform pruning and generate a pruning mask. And, it may extract a patch by using a pruning mask and generate an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124, and a patch packing unit 126.

A pruning unit 122 performs pruning for an additional image based on a pruning priority. Specifically, pruning for an additional image may be performed by using a reference image with a higher pruning priority than an additional image.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of the shape of a valid region, a patch is extracted in a square shape, so a patch extracted from a square valid region may include invalid data as well as valid data.

In this case, an aggregation unit 124 may re-partition a L-shaped or C-shaped patch that reduces encoding efficiency. Here, a L-shaped patch represents that the distribution of a valid region is L-shaped and a C-shaped patch represents that the distribution of a valid region is C-shaped.

When the distribution of a valid region is L-shaped or C-shaped, a region occupied by an invalid region within a patch is relatively large. Accordingly, a L-shaped or C-shaped patch may be partitioned into a plurality of patches to improve encoding efficiency.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map, or a Perspective Projection Format.

Here, an unpruned view image refers to a basic image with the highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 may pack a patch in a rectangle image. In patch packing, deformation such as size transform, rotation, or flip, etc. of a patch may be accompanied. An image that patches are packed may be defined as an atlas.

Specifically, packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of the arrangement structures of a camera rig, the accuracy of a depth map, or the number of view images.

A metadata generation unit 130 generates metadata for image synthesis. Metadata may include at least one of camera-related data, pruning-related data, atlas-related data, or patch-related data.

Pruning-related data may include information for determining a pruning priority between view images.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

An image encoding unit 140 encodes an atlas. When view images are classified into a plurality of groups, an atlas may be generated per group. Accordingly, image encoding may be performed independently per group.

An image encoding unit 140 may include a texture image encoding unit 142 encoding a texture atlas and a depth image encoding unit 144 encoding a depth atlas.

A bitstream generation unit 150 generates a bitstream based on encoded image data and metadata. A generated bitstream may be transmitted to an immersive image output device.

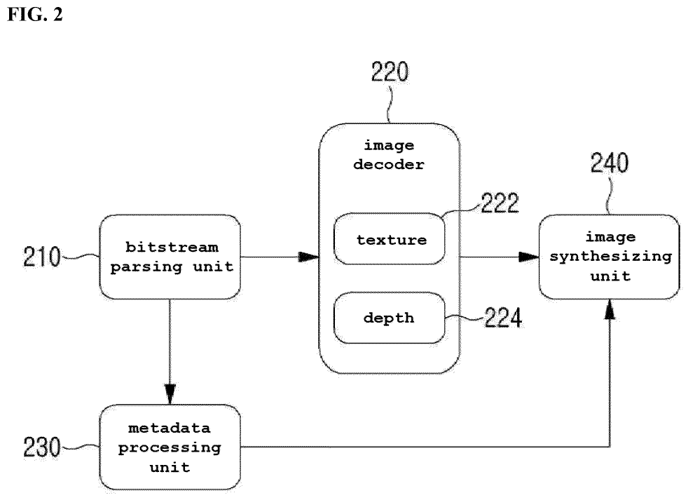

FIG. 2 is a block diagram of an immersive image output device according to an embodiment of the present disclosure.

In reference to FIG. 2, an immersive image output device according to the present disclosure may include a bitstream parsing unit 210, an image decoding unit 220, a metadata processing unit 230 and an image synthesizing unit 240.

A bitstream parsing unit 210 may parse image data and metadata from a bitstream. Image data may include data of an encoded atlas. When a spatial random access service is supported, only a partial bitstream including a watching position of a user may be received.

An image decoding unit 220 may decode parsed image data. An image decoding unit 220 may include a texture image decoding unit 222 for decoding a texture atlas and a depth image decoding unit 224 for decoding a depth atlas.

A metadata processing unit 230 may unformat parsed metadata.

Unformatted metadata may be used to synthesize a specific view image. In an example, when motion information of a user is input to an immersive image output device, a metadata processing unit 230 may determine an atlas necessary for image synthesis and patches necessary for image synthesis and/or a position/a size of the patches in an atlas and others to reproduce a viewport image according to a user's motion.

An image synthesizing unit 240 may dynamically synthesize a viewport image according to a user's motion. Specifically, an image synthesizing unit 240 may extract patches required to synthesize a viewport image from an atlas by using information determined in a metadata processing unit 230 according to a user's motion. Specifically, a viewport image may be generated by extracting patches extracted from an atlas including information of a view image required to synthesize a viewport image and the view image in the atlas and synthesizing extracted patches.

In order to effectively deliver an immersive video supporting 6DoF of rotational motion and positional movement to a HMD user, a MPEG Immersive Video (MIV)-based system, a standard for encoding and transmitting the immersive video of a MPEG standardization group, may be configured. A MIV encoder may receive a texture image, a geometric image and an intrinsic/extrinsic camera parameter for an obtained multi-view, minimize an inter-view redundancy, extract only pixel data necessary for rendering and output a packed texture atlas image, a geometric atlas image and metadata including other information necessary for reproduction.

In addition, in order to reproduce a wide range of immersive videos, a MIV encoder may group images into a plurality of groups and encode them in parallel, and a MIV decoder may partially decode and render only a group or an atlas required by a user among them. In this case, a plurality of groups may be MIV data representing a certain portion of the entire viewing space, as data partitioned based on a predetermined number of view units, visual similarity between view images, etc. When the partial decoding and partial space rendering are performed while switching a group or an atlas required for rendering as a user view position is changed, a wide range of immersive videos may be reproduced continuously even under limited performance and limited system resources of a terminal.

Here, in order for the configuration of the invention to operate smoothly, a method may be required which selects an optimal group or atlas for partition decoding and rendering by using a user's view information (a position, a direction, a movement speed, etc.) input from an external display device (a commercial HMD, etc.).

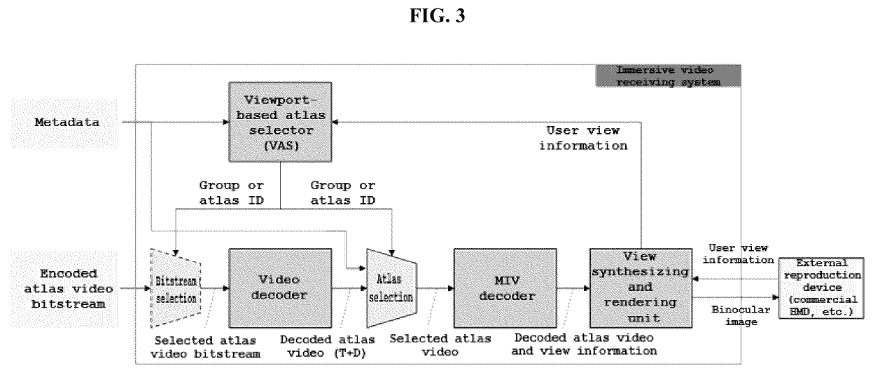

FIG. 3 shows the entire structure of an immersive video receiving system based on the configuration of the present disclosure.

The entire structure of an immersive video receiving system in FIG. 3 may be based on a configuration in FIG. 2.

An immersive video may be transmitted to a receiving system after being MIV(MPEG Immersive Video)-encoded. Among the MIV-encoded data, atlas video data may be image-encoded and transmitted.

An image decoder may receive an encoded atlas video bitstream to decode an atlas image. Here, an atlas video bitstream may be a bitstream selected based on a group or atlas ID.

A MIV decoder may perform MIV decoding by using metadata and an atlas video selected among the decoded atlas videos. The metadata may include a group or atlas ID.

A view image synthesizing and reproducing unit may synthesize and reproduce a binocular image corresponding to a user view by using an atlas video and view information decoded through a MIV decoder. In addition, a view image synthesizing and reproducing unit may be linked with an external reproduction device such as a commercial HMD, etc. to receive user view information and synthesize and reproduce a view image corresponding thereto in real time.

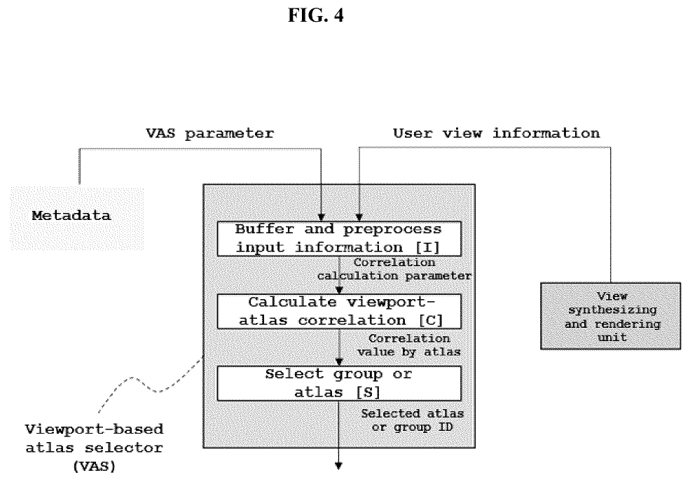

FIG. 4 is a diagram for specifically describing the operation process of a viewport-based atlas selector.

As mentioned above, in order to reproduce a wide range of immersive videos, MIV-encoded data may be data encoded in parallel by grouping the entire space into a plurality of groups. In this case, one group MIV data may be called TinyMIV. In this case, an immersive video receiving system may need to select an optimal atlas or group required by a user based on user view information. To this end, the viewport-based atlas selector (VAS) of the present invention may operate as in FIG. 4.

A VAS may receive at least one of metadata received by an immersive video receiving system or user view information (viewport information) received from a view image synthesizing and reproducing unit. In this case, user view information received from a view image synthesizing and reproducing unit may be information that has undergone a process corresponding to synthesis and reproduction in a view image synthesizing and reproducing unit. Unlike this, in this case, user view information received from a view image synthesizing and reproducing unit may be information that receives viewport information received from an external reproduction device as it is without going through a process corresponding to synthesis and reproduction in a view image synthesizing and reproducing unit. Alternatively, user view information received from a view image synthesizing and reproducing unit may be information that receives viewport information received from an external reproduction device as it is to perform only transform of a coordinate system without going through a process corresponding to synthesis and reproduction in a view image synthesizing and reproducing unit.

Referring to FIG. 4, a VAS may include at least one of an input information buffering and preprocessing unit, a viewport-atlas correlation calculation unit or a group or atlas selection unit.

An input information buffering and preprocessing unit may perform an input information buffering and preprocessing step. Specifically, a parameter (a VAS parameter) required for VAS operation in input metadata may be selected and buffered. In addition, user view information (viewport information) may also be buffered. In addition, a parameter required for viewport-atlas correlation calculation may be selected and transmitted to a viewport-atlas correlation calculation unit.

A viewport-atlas correlation calculation unit may perform a viewport-atlas correlation calculation step. Specifically, based on viewport information (user view information), a value corresponding to how much each atlas correlates with a view position may be output as a correlation value C( ).

A group or atlas selection unit may perform a group or atlas selection step. Specifically, a viewport-atlas correlation calculation unit may receive an atlas correlation value from a viewport-atlas correlation calculation unit to output a group or atlas ID required for MIV decoding and view image synthesis.

A viewport-atlas correlation calculation unit may output a group ID when a unit that partitions and renders a multi-immersive video in a receiving system is a group, and may output an atlas ID when a unit that partitions and renders a multi-immersive video is an atlas unit.

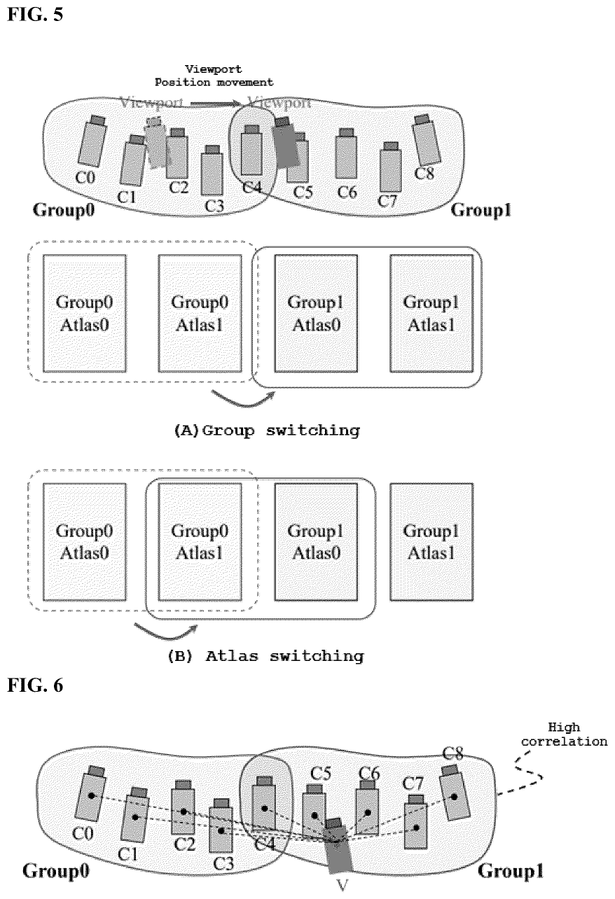

FIG. 5 shows an embodiment for a case where the unit of switching is a group and an atlas.

A group or atlas selection unit may select an optimal group or atlas based on a correlation value C( ) for each output group or atlas above. When a unit of switching is a group, an optimal group may be selected through Equation below by using C (V, Gᵢ) calculated between a viewport and each group.

$${G}_{idx} = arg {max}_{k} C ( V , {G}_{k} ) \qquad [ Equation 1 ]$$

A correlation calculated in a viewport-atlas correlation calculation unit may be defined differently according to various elements such as a camera arrangement, a grouping structure, a content characteristic, etc.

Referring to this, a group or atlas selection unit may select a group or an atlas according to any one of the four methods.

### [Method 1]

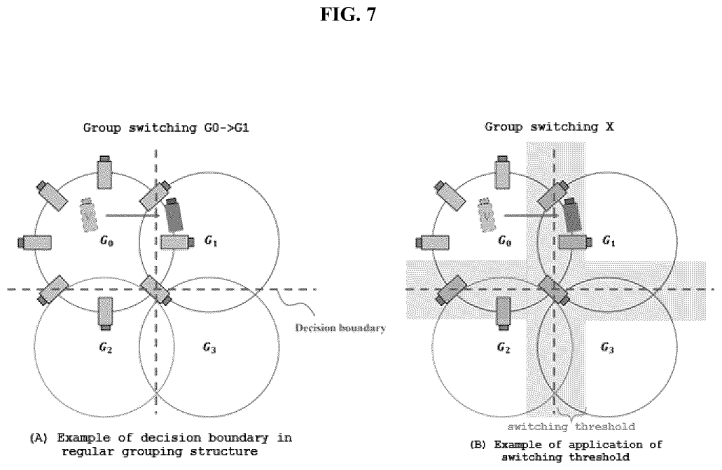

FIG. 6 shows an embodiment of a camera baseline-based VAS algorithm.

Referring to FIG. 6, when spatially adjacent cameras are configured as a group, a VAS may select a group or an atlas based on a baseline between a viewport and each camera.

$${C}_{baseline} ( V , {G}_{k} ) = \frac{M}{{\sum }_{i ∈ {G}_{k}} B ( V , {C}_{i} )} \qquad [ Equation 2 ]$$

As in Equation above, when a viewport (virtual camera) position is V, baseline B (Cᵢ, V) between V and all cameras {Cᵢ_{_{|i∈}} Gᵢ}configuring the k-th group Gᵢ is added and then, it may be determined that as this value is smaller, a correlation between V and the k-th group is higher. Here, M may be any positive number.

The Equation is an embodiment, and it may not necessarily use a reciprocal relationship, and any function that produces smaller C_{baseline} ( ) as the sum of baselines is larger may be used.

FIG. 7 shows contents related to an embodiment in which a group or an atlas is selected by using only a decision boundary.

In [Method 1], when a camera arrangement is structured and grouping is regularly performed based on a corresponding structure, a group or an atlas may be selected by using only a decision boundary without calculating a baseline with all cameras.

An embodiment for this case may be the same as in FIG. 7(A). Referring to FIG. 7(A), it may be an embodiment in which there are a total of four omnidirectional camera rigs in a scene space, the center of each camera rig is arranged the same distance away and one group is configured for each camera rig and is group-based MIV-encoded as G0 to G3.

In this case, a group with the highest correlation obtained by using the [Equation 2] may be completely the same as decision boundary-based group selection calculated by using only a distance from the center of a camera rig. Accordingly, computational complexity may be reduced by selecting an optimal group only through whether it crosses a decision boundary.

In [Method 1], when a user view moves irregularly near a position where a correlation value is reversed between groups (e.g., a decision boundary in FIG. 7(A)), switching between groups may occur too frequently. In order to compensate for this, switching between groups may be performed only when another group has a higher correlation value than a currently positioned group by a certain threshold or more. An example in which such a switching threshold is applied is shown in FIG. 7(B).

### [Method 2]

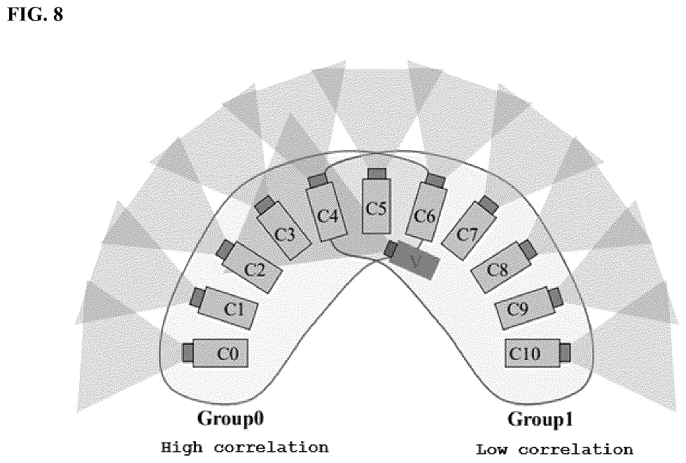

FIG. 8 shows an embodiment in which a group or an atlas is selected based on a view direction difference between a viewport and each camera.

A VAS may select a group or an atlas based on a view direction difference between a viewport and each camera.

$${C}_{angle} ( V , {G}_{k} ) = \frac{M}{{\sum }_{i ∈ {G}_{k}} A ( V , {C}_{i} )} \qquad [ Equation 3 ]$$

In Equation 3, A(V, Cᵢ) may refer to a view direction difference (angle) between virtual camera V and the i-th camera Cᵢ. As in Equation 3, when view direction difference A(Cᵢ, V) between V and all cameras {Cᵢ_{_{|i∈}} Gᵢ}configuring the k-th group Gᵢ is added and then, it may be determined that as this value is smaller, a correlation between V and the k-th group is higher. As in [Method 1], M is any positive number, and since the equation is just one embodiment, a reciprocal relationship may not necessarily be used. In other words, any function that produces smaller C_{angle} ( ) as the sum of view direction differences is larger may be used.

### [Method 3]

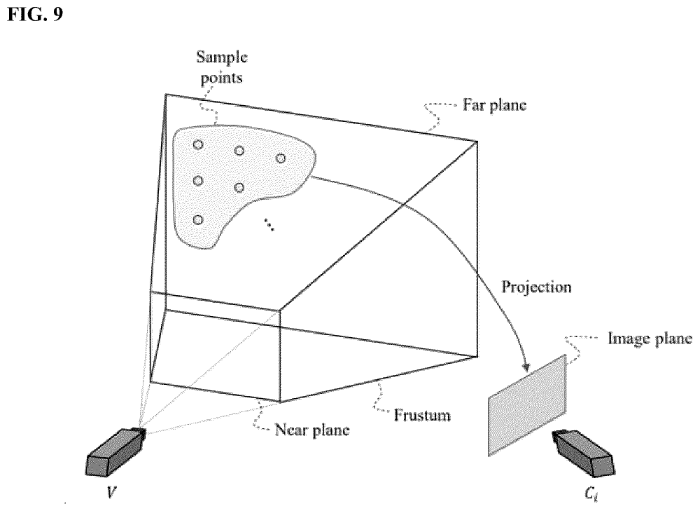

FIG. 9 shows an embodiment in which a group or an atlas is selected based on visibility for each camera for a viewport.

A VAS may select a group or an atlas based on visibility for each camera for a viewport.

In this embodiment, the frustum of a virtual view camera according to a viewport position may be defined.

When short and long distances of a scene are known, a corresponding value may be used, and when they are not known, it may be defined arbitrarily. After defining a frustum, N sample points may be defined within a corresponding space. And corresponding N samples may be projected onto the image plane of each input camera Cᵢ. Visibility between V and Cᵢ may be obtained based on how many points among all samples are projected into the image plane of Cᵢ.

$${C}_{visibility} ( V , {G}_{k} ) = {\sum }_{i ∈ {G}_{k}} Vis ( V , {C}_{i} ) \qquad [ Equation 4 ]$$

As in Equation 4, the sum of visibility with V of all cameras within Gᵢ may be used as a correlation between Gᵢ and V. A visibility value basically uses a ratio of how many of the N defined sample points are projected into an image, and may be reflected onto Vis( ) with a different weight for each sample point. For example, a higher weight may be given when a sample point is positioned in the center of a frustum, and a lower weight may be given when a sample point is positioned outside a frustum. Conversely, a higher weight may be given when a sample point is positioned outside a frustum, and a lower weight may be given when a sample point is positioned in the center of a frustum.

### [Method 4]

Based on a combination of all or part of [Method 1], [Method 2] and [Method 3], a VAS may select a group or an atlas.

$$C ( V , {G}_{k} ) = α \cdot {C}_{visibility} ( V , {G}_{k} ) + β \cdot {C}_{angle} ( V , {G}_{k} ) + γ \cdot {C}_{visibility} ( V , {G}_{k} ) \qquad [ Equation 5 ]$$

Here, α, β, γ may be 0 or any positive number. Here, 0 may represent that a corresponding method is not used. As an example, when only [Method 1] and [Method 2] are applied, γ may be 0. As an example, when only [Method 1] and [Method 3] are applied, β may be 0. As an example, when only [Method 2] and [Method 3] are applied, α may be 0.

In addition, the value of α, β and γ may be a pre-defined value or a value determined from a VAS parameter or user view information. In addition, the sum of α, β and γ may be 1.

A group or atlas selection unit may output the ID of a group or an atlas most suitable for a user based on the total correlation obtained, and based on this, a receiving system in FIG. 3 may select only a corresponding atlas.

A viewport-based atlas selection method, device and recording medium according to the present disclosure may include buffering and preprocessing metadata and user view information, calculating a correlation value representing a correlation at a user view position for each atlas based on the metadata and user view information, and selecting a group or an atlas used for MIV decoding and view image synthesis based on the correlation value.

In a viewport-based atlas selection method, device and recording medium according to the present disclosure, selecting the group or atlas may be performed based on a baseline between a viewport and each camera.

In a viewport-based atlas selection method, device and recording medium according to the present disclosure, when camera grouping is regularly performed based on a camera arrangement structure, selecting the group or atlas may be performed by considering only a decision boundary without considering a baseline with all cameras.

In a viewport-based atlas selection method, device and recording medium according to the present disclosure, the selected group or atlas may be selected as a group or an atlas having the highest correlation value with the user view position among a plurality of groups or atlases, and the plurality of groups or atlases may be divided by the decision boundary.

In a viewport-based atlas selection method, device and recording medium according to the present disclosure, in selecting the group or atlas, when the highest correlation value at the user view position is at a position exceeding a threshold from the decision boundary of a group or an atlas having the highest correlation value with a previous user view position, a group or an atlas having the highest correlation value with the user view position may be selected, and when the highest correlation value at the user view position is at a position not exceeding the threshold from the decision boundary of a group or an atlas having the highest correlation value with the previous user view position, a group having the highest correlation value with the previous user view position may be selected.

In a viewport-based atlas selection method, device and recording medium according to the present disclosure, selecting the group or atlas may be performed based on a view direction difference between a viewport and each camera.

In a viewport-based atlas selection method, device and recording medium according to the present disclosure, selecting the group or atlas may be performed based on visibility for each camera for a viewport.

In a viewport-based atlas selection method, device and recording medium according to the present disclosure, the visibility may be determined based on how much sample points within the frustum space of each camera are projected within the image plane of each camera.

In a viewport-based atlas selection method, device and recording medium according to the present disclosure, selecting the group or atlas may be performed based on a baseline between a viewport and each camera, a view direction difference between the viewport and each camera and visibility for each camera for the viewport.

Exemplary methods of the present disclosure are expressed as a series of operations for clarity of a description, but it is not intended to limit order in which steps are performed and if necessary, each step may be performed simultaneously or in different order. In order to implement a method according to the present disclosure, other step may be additionally included in an exemplary step or some steps may be excluded and the remaining steps may be included or some steps may be excluded and an additional other step may be included.

A variety of embodiments of the present disclosure do not enumerate all possible combinations, but are intended to describe a representative aspect of the present disclosure, and matters described in a variety of embodiments may be applied independently or in combination of two or more.

In addition, a variety of embodiments of the present disclosure may be implemented by hardware, firmware, software or a combination thereof. For implementation by hardware, implementation may be performed by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

A scope of the present disclosure includes software or machine-executable instructions which execute an operation according to a method of a variety of embodiments on a device or a computer (e.g., an operating system, an application, a firmware, a program, etc.), and a non-transitory computer-readable medium that such software or instruction, etc. is stored and executable on a device or a computer.

1. A viewport-based atlas selection method, the method comprising:
buffering and preprocessing metadata and user view information;
based on the metadata and the user view information, calculating a correlation value representing a correlation at a user view position for each atlas; and
based on the correlation value, selecting a group or an atlas used for MIV decoding and view image synthesis.

2. The method of claim 1, wherein:
selecting the group or the atlas is performed based on a baseline between a viewport and each camera.

3. The method of claim 1, wherein:
when a camera grouping is regularly performed based on a camera arrangement structure, selecting the group or the atlas is performed by considering only a decision boundary without considering a baseline with all cameras.

4. The method of claim 3, wherein:
the selected group or atlas is selected as a group or an atlas having a highest correlation value with the user view position among a plurality of groups or atlases,
the plurality of groups or atlases are divided by the decision boundary.

5. The method of claim 3, wherein in selecting the group or the atlas:
when a highest correlation value at the user view position is at a position exceeding a threshold from a decision boundary of a group or an atlas having a highest correlation value with a previous user view position, a group or an atlas having a highest correlation value with the user view position is selected,
when the highest correlation value at the user view position is at a position not exceeding the threshold from the decision boundary of the group or the atlas having the highest correlation value with the previous user view position, a group having the highest correlation value with the previous user view position is selected.

6. The method of claim 1, wherein:
selecting the group or the atlas is performed based on a view direction difference between a viewport and each camera.

7. The method of claim 1, wherein:
selecting the group or the atlas is performed based on a visibility for each camera for a viewport.

8. The method of claim 7, wherein:
the visibility is determined based on how many sample points within a frustum space of the each camera are projected within an image plane of the each camera.

9. The method of claim 1, wherein:
selecting the group or the atlas is performed based on a baseline between a viewport and each camera, a view direction difference between the viewport and the each camera and a visibility for the each camera for the viewport.

10. A viewport-based atlas selection device, the device comprising:
an input information buffering and preprocessing unit for buffering and preprocessing metadata and user view information;
a viewport-atlas correlation calculation unit for calculating a correlation value representing a correlation at a user view position for each atlas based on the metadata and the user view information;
a group or atlas selection unit for selecting a group or an atlas used for MIV decoding and view image synthesis based on the correlation value.

11. The device of claim 10, wherein:
the group or atlas selection unit selects a group or an atlas based on a baseline between a viewport and each camera.

12. The device of claim 10, wherein:
when a camera grouping is regularly performed based on a camera arrangement structure, the group or atlas selection unit selects a group or an atlas by considering only a decision boundary without considering a baseline with all cameras.

13. The device of claim 12, wherein:
the selected group or atlas is selected as a group or an atlas having a highest correlation value with the user view position among a plurality of groups or atlases,
the plurality of groups or atlases are divided by the decision boundary.

14. The device of claim 12, wherein in the group or atlas selection unit:
when a highest correlation value at the user view position is at a position exceeding a threshold from a decision boundary of a group or an atlas having a highest correlation value with a previous user view position, a group or an atlas having a highest correlation value with the user view position is selected,
when the highest correlation value at the user view position is at a position not exceeding the threshold from the decision boundary of the group or the atlas having the highest correlation value with the previous user view position, a group having the highest correlation value with the previous user view position is selected.

15. The device of claim 10, wherein:
the group or atlas selection unit selects a group or an atlas based on a view direction difference between a viewport and each camera.

16. The device of claim 10, wherein:
the group or atlas selection unit selects a group or an atlas based on a visibility for each camera for a viewport.

17. The device of claim 16, wherein:
the visibility is determined based on how many sample points within a frustum space of the each camera are projected within an image plane of the each camera.

18. The device of claim 10, wherein:
the group or atlas selection unit selects a group or an atlas based on a baseline between a viewport and each camera, a view direction difference between the viewport and the each camera and a visibility for the each camera for the viewport.

19. A computer readable recording medium storing a bitstream generated by a viewport-based atlas selection method, wherein the viewport-based atlas selection method includes:
buffering and preprocessing metadata and user view information;
based on the metadata and the user view information, calculating a correlation value representing a correlation at a user view position for each atlas; and
based on the correlation value, selecting a group or an atlas used for MIV decoding and view image synthesis.
